(19) United States
(12) Patent Application Publication
(10) Pub. No.: US 2010/0131419 A1
(43) Pub. Date: May 27, 2010

(54) SYSTEM AND METHOD FOR MANAGEMENT OF COMMODITY SHIPMENT DATA

(75) Inventors: Michael Lawrence Meagher, Hinton (CA); Robert Brilhart Lucke, Hinton (CA); Markus H. Plaum, Edmonton (CA)

Correspondence Address: DONALD V. TOMKINS;C/O TOMKINS LAW OFFICE, 740, 10150 - 100 STREET, EDMONTON, AB, T5J 0P6, CA

(73) Assignee: Aldata Software Management Inc., Hinton (CA)

(21) Appl. No.: 12/619,497

(22) Filed: Nov. 16, 2009

Related U.S. Application Data
(63) Continuation of application No. 10/174,980, filed on Jun. 20, 2002, now abandoned.

(51) Int. Cl. G06Q 10/00; G06Q 50/00

(52) U.S. Cl. 705/333

(57) ABSTRACT

A commodity shipment data management system includes a loader computer for storage of shipment data in a loader database. The system prompts the user to enter values for shipment data parameters, and prevents entry of invalid values. Data may also be entered remotely by wireless transmission. A GPS receiver collects loader location data and sends it to the loader computer. An output device records shipment data on a portable data storage medium which accompanies the shipment and is read into a destination weighscale computer. The system minimizes manual entry and transfer of data, reducing the risk of human error in data entry, and enhancing the reliability of the data. The GPS data facilitates verification of the geographical source and chain of custody of the shipped commodity, and, combined with data gathered by loader function sensors, facilitates detection of errors and fraudulent activity in connection with commodity shipments.

### CROSS-REFERENCE TO RELATED APPLICATIONS

This application is a continuation of application Ser. No. 10/174,980, filed Jun. 20, 2002, and the disclosure of said application Ser. No. 10/174,980 is incorporated herein by reference in its entirety to provide continuity of disclosure.

### FIELD OF THE INVENTION

The present invention relates to systems and methods for managing commodity shipment data, such as shipment contract particulars, commodity characteristics, and geographic source of the commodity. More particularly, the invention relates to systems and methods for gathering, recording, and accessing data relating to shipment of commodities by truck.

### BACKGROUND OF THE INVENTION

Accurate and reliable recording of information regarding shipment of commodities is important in many industries, such as the petroleum, agriculture, mining, aggregate, and recycling industries. It is particularly important in the timber and logging industry.

Although other methods of shipment are used in some circumstances, most log shipment is carried out by truck, using conventional or specially adapted tractor/trailer rigs. In the typical case, a trucker is hired to transport a load of logs from a site near the location where the logs were harvested. A loading machine (“loader”), operated by a loader operator, loads the logs onto the trailer. The loader operator prepares a bill of lading or waybill, indicating selected information about the loaded logs, such as species and grade. As well, the waybill typically contains commercial information regarding the terms of the contract between the owner of the logs and the customer purchasing of the logs, such as a sawmill or other wood-processing operation.

The trucker takes a copy of the waybill and proceeds to the customer's yard or other designated location, where the load of logs is weighed at a weigh scale to determine how much the customer must pay for the load. The information on the trucker's waybill must be recorded at the weigh scale, to give the customer a detailed record of the shipment, including information such as commodity attributes (e.g., class, species, grade), trucker identification, time and date of delivery, and contract information. The customer can later use this information to automatically “self-invoice” for the shipment and to verify payment invoices submitted by the log shipper, or for other purposes such as inventory control. Recording of load information at the scale may be done manually, by having the information from the waybill transcribed manually into a journal, by either the trucker or the scale operator. Alternatively, and more commonly in recent years, the waybill information may be entered into a weigh scale computer; again, this transfer of information may be carried out by either the trucker or the scale operator.

After the waybill information is recorded at the scale, it must be transferred to the customer's contract management and financial system (or “CMF”) for purposes such as determining the amount payable for the shipment, and confirming that the particulars of the shipment match control data stored in the CMF. This data transfer to the customer's CMF may be done in any of several ways. For example, where the waybill data is recorded in a scale computer, the data may be transferred on a floppy disk that is physically transported to and read into the CMF computer, or it may be transferred through a local area computer network (or “LAN”) connection or a telephone dial-up data transfer connection.

A number of significant problems and concerns can arise when commodity shipment information is recorded and managed according to the procedure described above. For obvious commercial reasons, the contract and load attribute information recorded on the waybill and at the weigh scale must be reliable, but ensuring the integrity of this information can be problematic. Errors can occur when the loader operator is entering the contract or load attribute information on the waybill. Errors can also occur when the trucker or scale operator is recording the information at the scale, possibly compounding errors made by the loader operator.

Data input errors can cause significant financial loss to either the shipper or the customer, yet these errors can be difficult or even impossible to discover or correct, especially with respect to load attributes, because there will commonly be no independent record of the load beyond the information entered on the waybill. This problem of ensuring integrity of load information is a concern when the information is being recorded on a computer just as much as when it is being recorded manually, as both methods involve the risk of human error.

Problems can occur even when there has been no error in the entry of data on the waybill or into the scale computer. A common problem is where the contract or load attribute information will not validate in the CMF. The usual cause is that the contract data control tables, if they exist at all, do not match the control data in the CMF due to differences in the syntax used for entering load data at the scale computer and for entering control data in the CMF computer. This generates errors when the data from the scale computer is transferred to the CMF computer, and it can be a very time consuming process to correct the errors reliably. This problem leads to extra cost in financial processing operations, and delays in collecting revenue and paying key suppliers and vendors.

Another drawback of traditional procedures is inherent inefficiency. Even if the loader operator makes no mistakes entering information on the waybill, and even if the trucker or scale operator makes no errors in transferring the information at weigh scale, the process of recording the information takes time, especially when care is being taken to avoid errors. Time saved in waybill preparation is time the loader operator could use to load more trucks, thus increasing profits. Time saved in data transfer at the weigh scale is time the trucker could use more profitably to get an earlier start on the way to pick up the next load. The same concerns apply when load data is transferred by the scale operator rather than the trucker, because the time involved is unproductive time for the trucker, who cannot leave until the data has been entered.

Traditional procedures can also lead to inefficiency of the scale operator, who may be inactive much of the time, with little or nothing productive to do unless there is a truck at the scale. However, the scale operator must be paid wages whether productively engaged or not. It is known for weigh scales to be automated in order to eliminate or reduce the need for full-time scale operators, relying on the truckers to record waybill data at the scale, such as entering it into a password-protected weigh scale computer. For reasons previously discussed, however, this approach is still susceptible to human error, especially because some truckers, not being directly accountable to the customer, may not be highly motivated to take reasonable care to ensure accuracy of their data entries into the weigh scale computer. Accordingly, customers may be prepared to tolerate the expense and inefficiency of having a full-time scale operator in order to have greater assurance that load data is accurately recorded. It would be beneficial, therefore, if reliance on a scale operator could be eliminated or reduced, without reducing the integrity and reliability of the data recorded at the scale.

Another significant concern is fraud, and in this regard it is helpful to understand the contractual relationships which may be involved in the shipment of bulk commodities such as timber and timber by-products. The owner or custodian of the timber may have a contract with one party to harvest the timber and load it for a trucker, who in turn has a separate contract with the owner to deliver the timber to the owner's customer. Alternatively, the owner may have separate contracts with separate parties for harvesting, loading, and trucking the timber. Another scenario is where a trucker or trucking company has its own tract of commercial timber, and its own supply and trucking contracts with various customers, in addition to delivery contracts it may have for other owners or customers. Because the areas where timber is harvested and stored are often remote, and because the owner often will not have a representative on site to monitor loading and shipping activities, there are opportunities for fraudulent activities in these types of operations.

One common type of fraud occurs where a load is delivered to a customer of the contractor, rather than the intended customer of the owner. This benefits the contractor, who gets paid for the commodity as well as for harvesting and loading it. The owner of the commodity receives no benefit from the load, and may never know the load was misappropriated.

This type of fraud may be illustrated by the following example. ABC Timber Co. owns tracts of timber ready to be harvested, and has a contract with 123 Sawmill Co. under which 123 is to pay ABC for logs delivered to 123's facility. ABC contracts with XYZ Logging Co. to harvest, load, and haul the logs from the ABC's tracts and to deliver the logs to 123's facility. For the most part, XYZ does as contracted, except that XYZ diverts one load out of twenty to a different customer, 789 Sawmill, which is not suspicious because XYZ has a separate delivery contract with 789. ABC does not become suspicious, because the volume of the diverted load is small enough that it is not missed from an area where hundreds of loads of logs are being harvested. Although this example involves timber shipment, similar frauds can occur in the shipment of other commodities as mentioned above.

Unfortunately, it is difficult to detect or prevent such fraudulent activities using conventional methods of recording and managing commodity shipment data. A dishonest loading contractor can easily enter falsified load information on a waybill. Alternatively, it is easy for a rogue trucker to record falsified data at unattended customer weigh scales.

An additional concern is the ability to verify the source and chain of custody of a given commodity shipment. Such ability would have obvious benefits in connection with fraud detection and prevention, but it is increasingly important for other reasons as well, particularly in the forestry industry. Consumers of wood products are becoming more concerned that the products they buy are made from wood harvested from tracts that are managed in a sustainable, environmentally-friendly manner. In fact, some manufacturers and retailers of wood products are now refusing to purchase raw lumber or finished wood products unless the source of the wood can be verified. As well, many “green” certification programs are now in effect to monitor environmental compliance and sustainability on the part of timber tract owners or proprietors. For these reasons, the, ability to prove the origin of the timber is increasingly demanded by certifiers, and by consumers who will only purchase “green-labelled” wood products. The problem is that traditional shipping data management methods rely entirely on paper waybills and unverifiable evidence as to the true origin of the wood.

Various systems and methods for tracking timber and lumber may be found in the prior art, including:
U.S. Pat. No. 5,604,715, issued to Aman et al., Feb. 18, 1997;
U.S. Pat. No. 5,960,413, issued to Amon et al., Sep. 28, 1999; and
U.S. Pat. No. 6,073,114, issued to Perkins III et al., Jun. 6, 2000.
   However, none of the inventions disclosed in these references address the foregoing problems effectively or at all.

Accordingly, there is a need for an improved system and method for gathering, storing, and managing information relating to the shipment of bulk commodities which:
(a) facilitates faster, more accurate, and more efficient entry of contractual and load attribute information on waybills at the point of loading, thereby reducing the risk of errors in information recorded on waybills;
(b) facilitates faster, more accurate, and more efficient transfer of waybill information to weigh scale computers, thereby reducing the risk of errors in information transferred from waybills;
(c) minimizes the need for detection and correction of errors in contractual and load attribute information recorded in CMF systems, thus minimizing delays in completing financial transactions relating to commodity shipments;
(d) minimizes or eliminates the need for reliance on weigh scale attendants for recording of waybill information;
(e) provides reliable and verifiable records regarding the geographical source of shipped commodities;
(f) facilitates “chain of custody” control for commodity shipments from the point of loading to the point of delivery;
(g) minimizes the possibility of inadvertent or intentional failure to record the loading or delivery of commodity shipments without such failure being readily detectable; and
(h) generally minimizes opportunities for fraudulent activities in connection with the shipment of bulk commodities.

### BRIEF SUMMARY OF THE INVENTION

The present invention is directed to the foregoing needs. In general terms, the invention is a system and method for gathering and managing data relating to shipment of a commodity by transport vehicles. Information regarding shipment contract details, commodity attributes, and the geographical source of the shipped commodity may be stored in a loader database in a computer mounted on the loader. Commodity attribute information and shipment contract information may be entered in the loader database through an appropriate user interface. Preferably, however, contract information may be entered in the loader computer database by wireless data transfer or by use of data storage media such as memory cards, floppy discs, or compact discs, thus virtually eliminating the risk of error in transferring the information as compared with manual data entry methods.

The invention also provides for gathering and recording data regarding loader activities (e.g., loader travel, boom lifts, etc.), thus providing information which may be analyzed for purposes of determining when the loader is loading, idle, or in transit.

Selected information from the loader database may be recorded on a portable data storage medium, such as a memory card, floppy disc, compact disc, or bar-coded waybill, which travels with the shipment to its destination. The information from the portable data storage medium may be transferred to the database of a computer at a weigh scale at the destination point using an appropriate data reading device, with virtually no risk of human error in the data transfer. Information in the loader computer and the scale computer may he audited for a variety of purposes, including confirmation of whether all loads were recorded and whether all loads were delivered as intended, and for determining the geographic source of the loads.

Accordingly, in one aspect the invention is a loader data management system for gathering and managing data relating to a commodity shipment loaded onto a transport vehicle by a loader, said system comprising:
(a) a loader computer mounted on the loader, said loader computer having a loader database;
(b) shipment data input means, for entering commodity shipment data in the loader database;
(c) shipment data output means, for recording data from the loader database onto a portable data storage medium; and
(d) a power source.

The invention may include global positioning system (“GPS”) receiving apparatus for receiving GPS data corresponding to the geographical coordinates of the loader at the beginning and end of selected time intervals, and for recording the GPS data in the loader database. The invention may also include motion detection means associated with the loader, wherein the loader computer is programmed to begin recording the GPS data when the motion detection means detects loader movements corresponding to selected threshold criteria. The preferred embodiment includes a signal interruption sensor for detecting and recording any disruption or attempted disruption of the connection between the GPS receiving apparatus and the loader computer.

The invention may also include loader function sensors, for detecting activation of one or more loader functions, whereupon recording corresponding information may be recorded in the loader database.

The power source typically will be provided by a connection to the electrical system of the loader, although power may also be provided by a dedicated storage battery. In the preferred embodiment, the invention will include a back-up battery to ensure continuity of power supply in the event of interruption or failure of the primary power source, and a power interruption sensor for detecting and recording any disruption or attempted disruption of the power source.

The shipment data input means may include a wireless data transmission system, whereby shipping contract data may be entered in the loader database from a location remote from the loader. The shipment data input means may also include a device for reading data from a data storage medium such as a memory card, floppy disc, or compact disc.

In the preferred embodiment, the loader computer is programmed to give the user a choice of languages for entry of data. The loader computer is also programmed to display shipment data prompts and commodity attribute prompts, with corresponding menus of input values which the user may select through a user interface. Also in the preferred embodiment, the loader computer is programmed to be “self-filling”; i.e., automatically entering particular further input values upon entry of specific “triggering” input values.

The user interface may include a keypad or a touch-screen interface.

The portable data storage medium may be a bar code printed on a waybill and the shipment data output means may include a bar code printer, for printing selected data from the loader database on the waybill. Alternatively, the portable data storage medium may include a data storage medium, such as a memory card, magnetic card, floppy disc, or compact disc, and the shipment data output means may include a recording device for recording selected data from the loader database on the data storage medium. In the preferred embodiment, the data storage medium may be inserted into a computer on the transport vehicle, such that data relating to operation of the transport vehicle may be recorded onto the data storage medium.

The shipment data output means may include a wireless data transmission system, and the portable data storage medium may be an onboard database on the transport vehicle, adapted to receive and store data from the wireless data transmission system.

The shipment data output means may include a radio frequency identification system, and the portable data storage medium may include a read/write memory chip having an embedded identification, onto which data may be recorded, or from which data may be read, by scanning the memory chip with an electromagnetic signal such as a microwave or RF (radio frequency) signal.

In another aspect, the invention is a scale data management system for recording data relating to a commodity shipment delivered to a weigh scale on a transport vehicle, said system comprising:
(a) a scale computer associated with the weigh scale, said scale computer having a scale database; and
(b) shipment data input means, for receiving data relating to the commodity shipment and for recording said data in the scale database.

The shipment data input means may include a bar code reader. In one alternative embodiment, the shipment data input means may include a device for reading data from a data storage medium. In a further alternative embodiment, the shipment data input means may include a wireless receiver, for receiving data transmitted by a wireless data transmission system.

In the preferred embodiment, the scale computer is programmed to give the user a choice of languages for entry of data. The loader computer is also programmed to display shipment data prompts and corresponding menus of input values which the user may select through a user interface. Also in the preferred embodiment, the scale computer is programmed to be “self-filling”; i.e., automatically entering particular further input values upon entry of specific “triggering” input values.

In the preferred embodiment, the invention further comprises scale data transfer means associated with the scale computer, for transferring selected data from the scale database to a facility remote from the scale, such as a customer's CMF computer system. The scale data transfer means may include a data recording device for recording, selected data from the scale database may be recorded on a data storage medium, or it may include a wireless data transmission system.

In a further aspect, the invention is a method of analyzing data relating to the operation of a commodity loader, said data including GPS data corresponding to the geographical coordinates of the loader at the beginning and end of selected time intervals over a selected sampling period, said method comprising the steps of:
(a) calculating the distance between the loader's location at the beginning and end of each time interval in the sampling period; and
(b) calculating the average travel speed of the loader during each time interval.

In the preferred embodiment, the method also includes the step of making a provisional determination as to whether the loader was loading a commodity during the sampling period, by determining in accordance with a pre-determined protocol whether the loader's average travel speed during each interval was higher or lower than a selected threshold travel speed. The method may also include of the steps of:
(a) calculating the loader's radius speed (defined hereinafter) over a selected time interval; and
(b) making a provisional determination as to whether the loader was loading a commodity during the selected time interval, by determining in accordance with a pre-determined protocol whether the loader's radius speed during the interval was higher or lower than a selected threshold radius speed.

In the preferred embodiment of the method, the data relating to the operation of the loader includes loader function data which records the times of activation of a selected loader function (e.g., an electrical, mechanical, or hydraulic function) over a selected sampling period, and the method comprises the further step of determining the frequency of activation of the selected loader function during the sampling period. The method may also include the step of making a provisional determination as to whether the loader was loading a commodity during the sampling period, by determining in accordance with a pre-determined protocol whether the frequency of activation of the selected loader function during each interval was higher or lower than a selected threshold frequency.

### BRIEF DESCRIPTION OF THE DRAWINGS

Embodiments of the invention will now be described with reference to the accompanying figures, in which numerical references denote like parts, and in which:

FIG. 1 is a schematic drawing of the loader data management system of the invention.

FIG. 2 is a schematic drawing of the scale data management system of the invention.

FIG. 3 is an exemplary flow chart illustrating one possible configuration of shipment data parameters for entry into the loader or scale data management system.

FIG. 4 is an exemplary table illustrating one possible configuration of prompts for entry of shipment data into the loader or scale data management system.

FIG. 5 is an exemplary graph illustrating one possible output format for data related to loader activity.

FIG. 6 is an exemplary graph illustrating a further possible output format for data related to loader activity.

### DETAILED DESCRIPTION OF THE PREFERRED EMBODIMENT

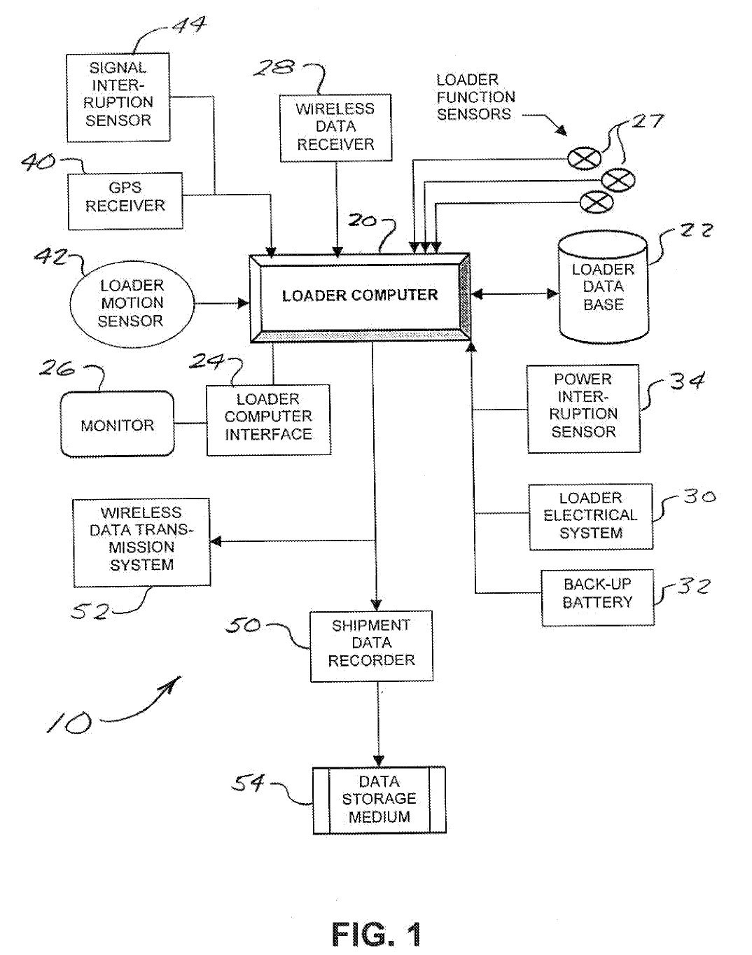

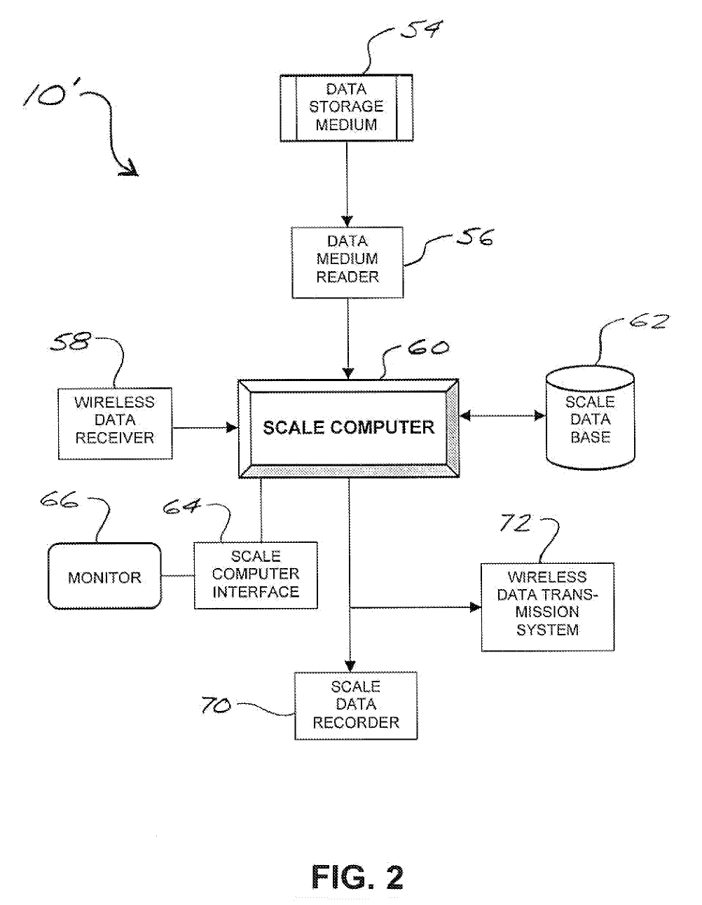

The system of the invention is schematically illustrated in FIGS. 1 and 2. As shown in FIG. 1, a loader data management system, generally denoted by reference numeral 10, has a loader computer 20 and a loader database 22, which are installed on or in a commodity loader (not shown). The loader computer is connected to a primary power source, which may be a battery forming part of the loader's electrical system 30, or perhaps a separate storage battery. In the preferred embodiment the system includes a back-up battery 32 to ensure uninterrupted power to the loader computer 20 and related components should the supply of power from the primary power source be disrupted for any reason. Although not shown in FIG. 1, switching apparatus of any suitable and well-known type may be provided for automatically activating the flow of electrical current from back-up battery 32 upon the occurrence of such a disruption.

The preferred embodiment also features a power interruption sensor 34 which will detect any disruption or attempted disruption of the flow of electrical current to the loader computer 20, and will in such event will also send a corresponding signal to the loader computer 20, whereby the particulars of the disruption (e,g., nature, time, and duration of disruption) may be recorded in the loader data base 22. If the power interruption sensor 34 records an attempted or actual disruption, this information will alert the system user to the possibility that there is a defect in the power supply system, or that there has been an attempt to tamper with the power supply system, whereupon the user may take appropriate investigative, remedial, and precautionary measures. Whatever the reason for the disruption may be, a person analyzing data from the loader database 22 will be alerted to the possibility that the data may be inaccurate or incomplete because of the power disruption.

In the preferred embodiment, the loader data management system 10 includes a GPS (“Global Positioning System”) receiver 40 connected to the loader computer 20. The GPS receiver 40 may be set to sample GPS data corresponding to the geographic location of the loader at user-specified time intervals. This GPS data may be transmitted to the loader computer 20 for storage in the loader database 22. The preferred embodiment also includes a loader motion detector 42, which sends a signal to the loader computer 20 upon detecting any movement of the loader, in accordance with user-selected movement criteria. Various known movement detection devices may be used or readily adapted for this purpose. Upon receiving a signal from the movement detector 42, the loader computer 20 will begin recording readings from the GPS receiver 40 as to the position of the loader. This feature provides for efficiency collection and storage of GPS data by ensuring that GPS readings are not being taken and recorded when the loader is stationary, thus conserving memory space in the loader database 22.

The GPS data has numerous potential uses and benefits, including in particular the ability to identify or confirm the geographic source of commodity shipments. Using the preferred embodiment of the loader data management system 10, selected data related to a commodity shipment, including GPS data as to the geographic location of the loader during loading operations, may be recorded on appropriate media (discussed further hereinafter) which travel with the shipment. If the loading point was reasonably close to the source of the commodity, the geographical location of the loader during loading will correspond reliably to the geographic source of the commodity. In effect, therefore, the GPS feature of the invention allows for geographical “stamping” of commodity shipments. This can be beneficial from the standpoint of resource management, such as to confirm that the shipped commodities originated at approved or preferred sources, such as timber harvested under a sustainable resource management plan rather than from old-growth forests. This information can also be applied advantageously in the marketing of end products made from the commodities in question, such as wood furniture, with obvious benefits in cases where retailers or consumers may refuse to purchase products without reasonable assurance that they came from environmentally-friendly sources.

The preferred embodiment of the loader data management system 10 also includes a signal interruption sensor 44 which will detect any disruption or attempted disruption of the flow of GPS data to the loader computer 20, and will in such event will also send a corresponding signal to the loader computer 20, whereby the particulars of the GPS disruption (e.g., nature, time, and duration of disruption) may be recorded in the loader data base 22. If the signal interruption sensor 44 records an attempted GPS disruption, this information will alert the user to the possibility that there is a defect in the GPS system, or that there has been an attempt to tamper with the GPS system, whereupon the user may take appropriate investigative, remedial, and precautionary measures. Whatever the reason for the disruption may be, a person analyzing data from the loader database 22 will be alerted to the possibility that the data may be inaccurate or incomplete because of the GPS disruption.

The loader data management system 10 includes shipment data input means, which may take one or more of several possible forms. In one embodiment, the shipment data input means includes a loader computer interface 24 and a monitor 26. The loader computer interface 24 may be a conventional computer keyboard or other similar type of keypad interface. In the preferred embodiment, however, the loader computer interface is a touchscreen interface of known type, whereby data entries may be made by touching the, monitor screen 26 in selected areas corresponding to data entry values displayed in accordance with protocols programmed in the loader computer 20.

Also in the preferred embodiment, the shipment data input means includes a wireless data receiver 28, which allows for shipment contract data to be entered into the loader computer 20 and the loader database 22 from a location remote from the where the commodity shipment is being loaded, via a wireless data transmission system. The wireless data transmission system may be any suitable system, such as a cellular digit packet data system, a private packet radio system, or a satellite packet data system. In a further embodiment, the shipment data input means includes a data medium reader (not shown) device such as a memory card reader, magnetic card reader, floppy disc drive, or compact disc drive, to accommodate commodity shipments where the shipment contract data is recorded on a portable data storage medium such as a memory card, magnetic card, floppy disc, or compact disc, respectively. The data storage medium containing this information may be given to the trucker before the trucker leaves for the loading point, or it may be delivered in advance to the loading point in anticipation of the trucker's arrival.

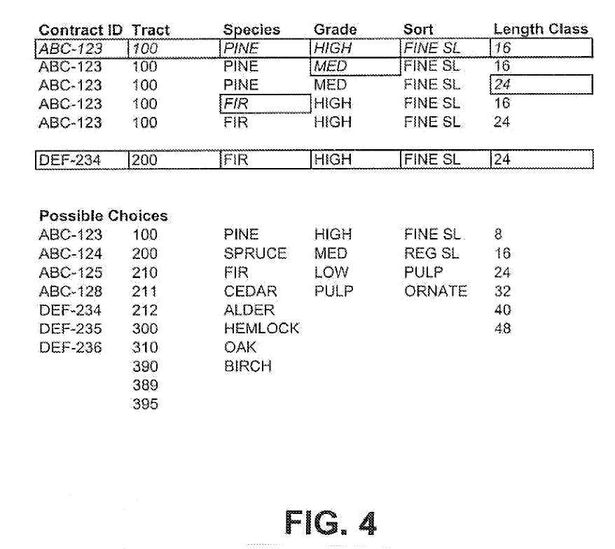

The benefits of being able to enter shipment contract data via a wireless data transmission system or a portable data storage medium may be better understood with reference to an example (based on FIG. 4). ABC Timber Co. has contracted XYZ Logging Co. to harvest, load, and haul a shipment of logs from one of ABC's tracts designated as Tract 100 for delivery to the scale at 123 Sawmill Co. The contract, with assigned “Contract ID No. ABC-123”, requires the logs to be a mix of “High” and “Medium” grade pine and fir logs coming within sort class “Fine SL” and length class “16” or “24”. All of this contract information can be transmitted to the loader computer 20 via the wireless data receiver 28 in advance of the trucker arriving at the loading site. The only information the trucker needs to have is the contract ID number, which may be given to the loader operator upon arrival at the loading site. The loader operator then retrieves the shipment particulars for that contract from the loader database 22 and proceeds to load the trucker's vehicle accordingly. Where the contract information has instead been written onto a floppy disc (or other portable data storage medium), the floppy disc is read into the loader database 22 and is retrieved by the loader as necessary.

The ability to enter contract data by these procedures eliminates the need for the trucker to have a paper manifest or order form containing the contract information, as well as the need for manual entry of such information, thus greatly reducing the chances that the shipment will be loaded incorrectly or sent to the wrong destination. However, in cases where the trucker provides the contract information in the form of a paper manifest or order, the system 10 also accommodates manual entry of this information via the loader computer interface 24.

The loader computer interface 24 is also used by the loader operator to enter data into the loader computer 20 relating to various commodity attributes of the shipment as loaded. The commodity attributes could include parameters such as a commodity class, a commodity subclass, a species class, a grade class, and a length class, which would be particularly useful parameters for purposes of shipping timber commodities. It is a feature of the present invention, however, that the commodity attributes user may defined, configured, and applied as the user may desire, by programming the loader computer using methods well known in the programming art.

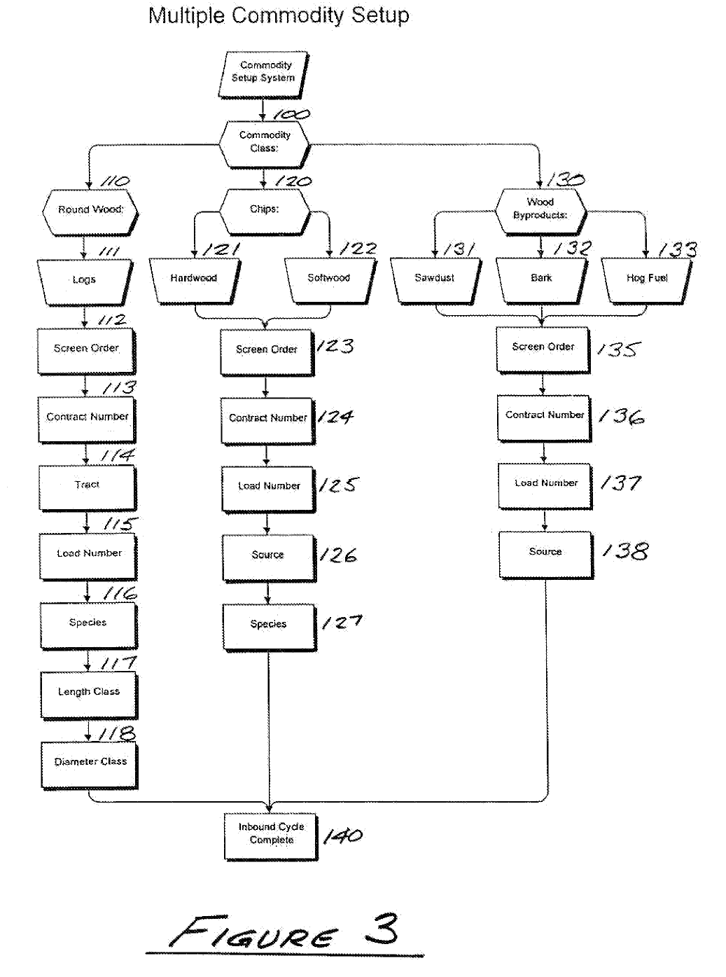

FIG. 3 illustrates one possible configuration or hierarchy of contract parameters and commodity attributes, in the specific context of the timber industry. As suggested above, the protocol governing the entry of corresponding values into the loader database 22 via the loader computer interface 24 is flexible according to the user's preferences. For example, the loader computer 20 could be programmed to display on the monitor 26 an initial prompt 100 for the loader operator (or other person entering data) to enter the “Commodity Class” for the shipment, with the loader computer 20 being programmed to accept the selection of any of three commodity classes, namely “Round Wood” 110, “Chips” 120, or “Wood Byproducts” 130, as shown in FIG. 3. Upon selection of a commodity class, a choice of commodities would be displayed.

If the user enters “Round Wood” 110, the only valid commodity entry in the example would be “Logs” 111, which would be automatically selected and entered (i.e., “autofilling”). If the user selects “Chips” 120, the user would then be prompted to choose a commodity from “Hardwood” 121 or “Softwood” 122. Where the user selects “Wood Byproducts” 130, three commodity choices would be displayed for selection. Once a commodity has been selected and entered, the loader computer 20 determines an array and sequence of further user-defined prompts (or “screen order”, as designated in FIG. 3 by reference numerals 112, 123, and 135, according to the commodity class) appropriate for the shipment, in accordance with a programmed protocol. These further prompts are designated for illustration purposes in FIG. 3 by reference numerals 113 to 118, 124 to 127, and 136 to 138. Entering a value at these prompts may involve keying in data in alphanumeric characters. Alternatively or additionally, the system may be configured to display various options (e.g., “Hardwood” 121 or “Softwood” 122, under the “Chips” prompt 120) which could be selected by keying in a specified code (which, for example, might be defined as the letter “H” for “Hardwood” or “S” for “Softwood”) or, where a touchscreen interface is being used, by touching a selected screen area. Whatever method is used for data entry, once a value has been entered at each prompt, the data entry process for the shipment will reach the completion stage, as designated by reference numeral 140 in FIG. 3

The foregoing is merely one example of how the system of the invention could be configured and operated for purposes of data entry. Well known programming techniques would facilitate many variations according to the user's preferences. For instance, the data entry routine in the preceding example might be made more user-friendly by commencing with entry of a commodity (e.g., Logs, Hardwood, Bark, etc.), which in addition to triggering the screen ordering process would automatically enter the corresponding commodity class into the loader database 22, eliminating that step for the user.

the preferred embodiment, the loader computer 20 is programmed to filter out certain data values which would not be valid entries in view of values previously entered. This feature may be better understood with reference to FIG. 4, which illustrates only one example of how the shipment data input prompts might be configured for use in connection with timber shipments. In such context, where the commodity being shipped comprises timber, the term “timber shipment data” may be used in reference to shipment data relating to timber shipments. The user-defined shipment data parameters in this example are CONTRACT ID, TRACT, SPECIES, GRADE, SORT, and LENGTH CLASS. There are several possible user-defined values which could conceivably be entered for each shipment data parameter, as shown in the lower part of FIG. 4. However, if shipment in question is under Contract ID No. ABC-123 (see prior example), it must contain only high and medium, grade pine and fir logs of “Fine SL” sort class and length class 16 or 24, harvested from Tract 100. Accordingly, when the user selects Contract ID No. ABC-123, the monitor displays only those entries corresponding to the commodity attributes stipulated under that contract. The other values (such as Tracts 200, 210, 211, etc.; species Spruce, Cedar, Alder, etc.; grades “Low” and “Pulp”; sort classes “Reg. SL”, “Pulp”, and “Ornate”; and length classes 16, 32, 40, and 48) are “locked out” and cannot be entered. Where there is only one valid entry (such as “Fine SL” for the sort class in the example), that value will be “autofilled” without the user needing to make a corresponding entry.

It will be readily seen that the foregoing filtering and “autofill” features will reduce the risk of inaccurate recording of commodity shipment data. These and other features of the invention also can serve as a check for the loader operator as to the requirements of the shipment, thus reducing the risk of the wrong commodity being loaded, and the risk of the shipment being sent to the wrong destination.

In the preferred embodiment, the scale computer 20 is also programmed to display a language prompt to give the, user a choice of languages for entry of data into the scale data base 22, further reducing the risk of incorrect manual data entries.

In the preferred embodiment, the loader data management system 10 includes one or more loader function sensors 27 mounted on or in the loader and connected to the loader computer 20, as illustrated in FIG. 1. Each loader function sensor 27 detects a selected loader function, such as a particular electrical, mechanical, or hydraulic function, as the user may desire. Upon activation or deactivation of its corresponding loader function, each loader function sensor 27 sends a signal to the loader computer 20 which in turn enters a corresponding record in the loader database 22. Sensors adequate or readily adaptable for such purposes are well known in the prior art. The information obtained from the loader function sensors 27 may be used as desired, and in particular for purposes which will be described in detail below.

In one embodiment of the invention, a loader function sensor 27 is provided to sense each lifting or lowering of the boom of the loader. Each data record of a boom lift will represent an indication that the loader was lifting a load of the commodity in question, such as lifting a load of logs from a log pile. Each data record of the boom being lowered will represent an indication that the loader was lowering a load, such as onto a transport vehicle. While such indications may not be conclusive, they can be helpful to system users or administrators in monitoring loader activities.

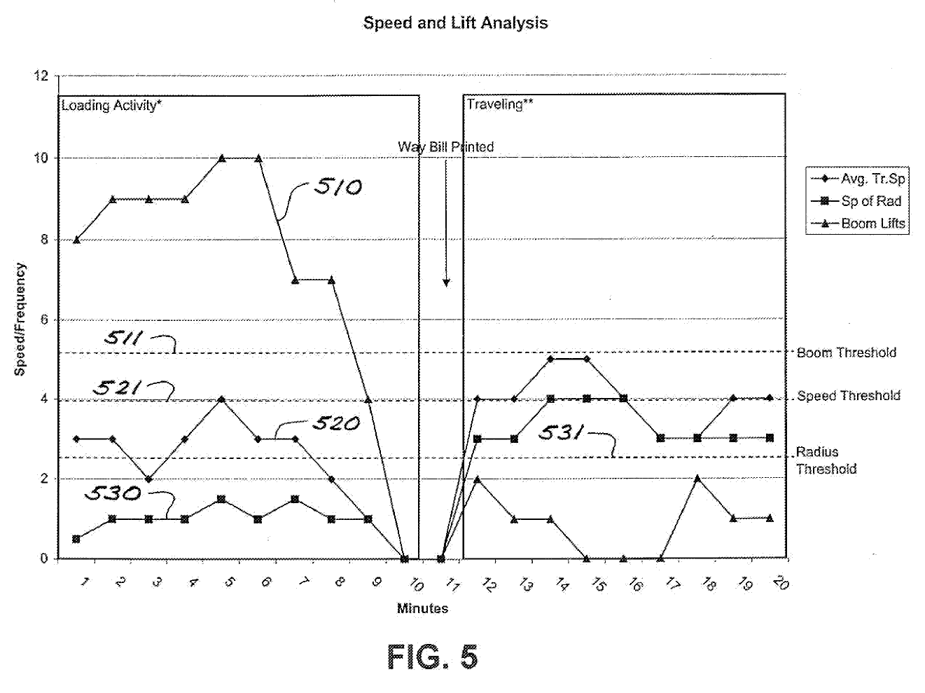

Such utility may be best understood with reference to FIG. 5, which is an exemplary graph plotting (among other values, discussed further below) the frequency of loader boom lifts over a 20-minute period. The plotted data relating to boom lift frequency are denoted by reference numeral 510. In this example, there were between 7 and 10 boom lifts per minute during the first 8 minutes; then the frequency dropped sharply, and there were no lifts at all between the 9.5-minute mark and the 10.5-minute mark. This would be explained by the fact that the loader was busy loading a transport vehicle during the first 8 minutes or so, and after loading was complete, the loader was idle while the operator generated a waybill (or other form of shipment data record, as discussed further below) for the load.

A system user or administrator, upon analyzing a sufficient amount of such data, may determine that boom lift frequencies above a certain threshold value (the “boom threshold”) suggest that the loader was loading during the time in question. In the example in FIG. 5, the boom threshold, indicated by reference numeral 511, has been determined as approximately 5.2 lifts per minute. Accordingly, when boom lift frequency is significantly lower than the boom threshold, such as between the 10-minute and 20-minute marks in FIG. 5, this will suggest that the loader was not loading during that time period. While this information may not always facilitate a conclusive determination as to whether the loader was loading or not, it can be useful in a number of ways, such as detection and prevention of errors and fraud. If there is a period of high boom lift frequency (such as in the first 8 minutes in FIG. 5), followed by a period of low boom lift frequency, but no waybill was generated after the period of high boom lift frequency, the user or administrator will be alerted to the need for investigation. In an innocent case, the loader operator may simply have forgotten to generate the waybill. However, there would also be the possibility that the operator purposely did not generate a weigh bill and was party to a scheme to misappropriate the loaded commodity. In any event, the system user or administrator can take appropriate investigative and remedial steps.

The knowledge that the loader data management system 10 provides information of this kind will be a deterrent to rogue loader operators and truckers who, might otherwise be tempted to defraud the commodity owner. This benefit is particularly advantageous where commodities are being loaded in remote areas where it is difficult or impractical for the commodity owner to have a representative on site to monitor and supervise loading operations.

FIG. 5 is also helpful to illustrate the practical usefulness of the GPS data collected by the GPS receiver 40 and stored in the loader database 22. The loader computer 20 can be programmed to calculate the loader's average travel speed based on the distance between its geographic positions at the start and end of a selected sample period. When the sample period is fairly small (5 seconds, for instance), such calculations will provide a reasonably accurate indication of the loader's average speed during that time. FIG. 5 illustrates how these travel speed readings might be plotted, as indicated by reference numeral 520. A system user or administrator, upon analyzing a sufficient amount of such data, may determine that average travel speeds below a certain threshold value (the “speed threshold”) suggest that the loader was loading during the time in question, given that loaders generally travel more slowly when loading than when travelling between loading tasks.

In the example in FIG. 5, the speed threshold, indicated by reference numeral 521, has been determined as approximately 4 kilometers per hour. Accordingly, when travel speed readings are at or above the speed threshold, such as between the 10-minute and 20-minute marks in FIG. 5, this will suggest that the loader was not loading during that time period, but rather was in transit between tasks. This information may be used in much the same way as the boom lift information discussed previously. If there is a period of travel speeds generally below the speed threshold (such as in the first 10 minutes in FIG. 5), followed by a period of higher travel speeds, but no waybill was generated after the period of lower travel speeds, the user will be alerted to the need for investigation as to whether there has been fraudulent activity or perhaps only an innocent mistake.

The GPS data can also be processed to calculate the loader's radius speed, which as used herein means a value that provides an indirect indication as to the loader's radius of operations during a user-specified time interval. The radius speed is calculated in essentially the same way as the travel speed, except that the user-specified time interval is significantly larger than the sample period used for travel speed calculations. For example, the selected time interval for radius speed calculations might be one minute (as compared with a 5-second sample period for travel speed calculations). If the loader is engaged in loading operations (e.g., travelling back and forth from a transport vehicle to a nearby commodity storage pile), the distance between its geographical locations at the beginning and end of the sample period will be fairly small; it would be no greater than the distance between the vehicle and the pile, and could in fact approach zero. The corresponding radius speed will also be very small, especially as compared to the travel speed, given that the time interval for radius speed calculations is much larger. On the other hand, if the loader is in transit rather than loading a vehicle, and especially if the loader is travelling in a substantially uniform direction during the sample period, the radius speed will be much higher than when loading, and may in fact approach the travel speed.

FIG. 5 illustrates how such radius speed values might be plotted, as indicated by reference numeral 530. A system user or administrator, upon analyzing a sufficient amount of such data, may determine that average radius speeds below a certain threshold value (the “radius threshold”) suggest that the loader was loading during the time in question. In the example in FIG. 5, the radius threshold, indicated by reference numeral 531, has been determined as approximately 2.6 kilometers per hour. Accordingly, when radius speed readings are at or above the radius threshold, such as between the 10-minute and 20-minute marks in FIG. 5, this will suggest that the loader was not loading during that time period, but rather was moving between tasks. This information may be used in much the same way as the boom lift and travel speed information discussed previously. If there is a period of radius speeds below the radius threshold (such as in the first 10 minutes in FIG. 5), followed by period of higher radius speeds, but no waybill was generated after the period of lower radius speeds, the user will be alerted to the need for investigation as to whether there has been fraudulent activity or perhaps only an innocent mistake.

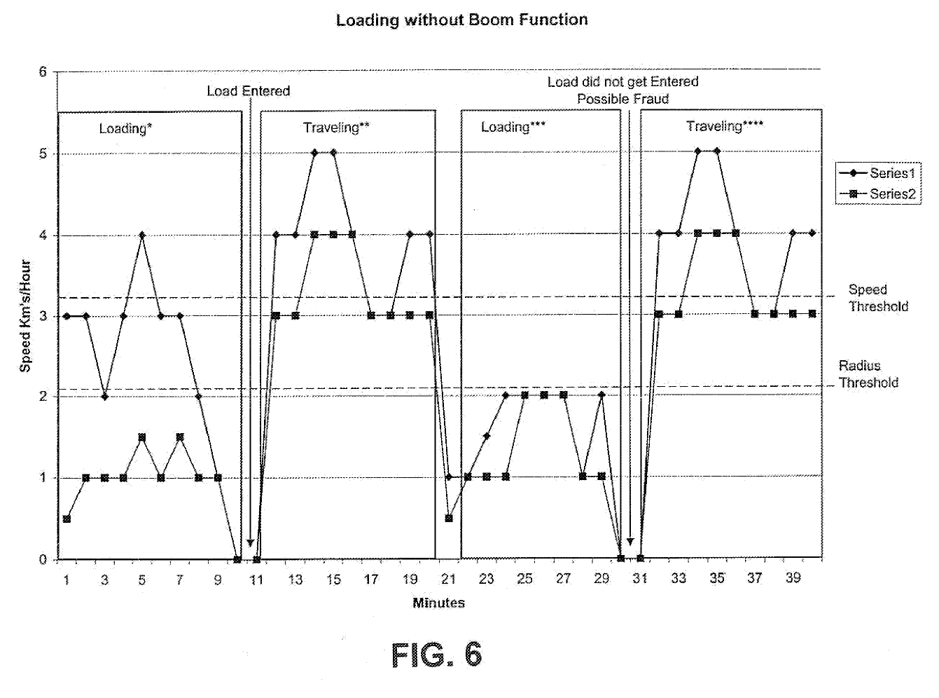

An understanding of the application of the travel speed and radius speed data will be further enhanced by reference to FIG. 6, which presents another illustrative example of such readings plotted with reference to user-designated speed and radius threshold values.

After a commodity shipment has been loaded on the transport vehicle and all necessary or desired shipment information has been entered into the loader database 22, it is necessary to generate a shipment data record to accompany the shipment to its destination. Accordingly, the loader data management system 10 includes shipment data output means, for recording data from the loader database onto a portable data storage medium 54, as indicated in FIG. 1. The shipment data output means may be any suitable shipment data recorder 50, such as a a bar code printer, memory card writer, magnetic card writer, floppy disc drive, or compact disc burner. In such cases, the portable data storage medium 54 will be a bar code (written onto a waybill or other convenient carrier medium), memory card, magnetic card, floppy disc, or compact disc, respectively. In the preferred embodiment, the data storage medium may be read into a computer on the transport vehicle so that data relating to operation of the transport vehicle may be recorded onto the data storage medium, thus expanding the range of data which may be recorded in connection with commodity shipments.

Alternatively or additionally, the shipment data output means may be a wireless data transmission system 52, with the portable data storage medium 54 being an onboard database on the transport vehicle (not shown). In this embodiment, the transport vehicle will be equipped with a wireless data receiver for receiving shipment data from the wireless data transmission system and communicating same to the onboard database. The wireless data transmission system may be a close proximity data transmission system.

In a further embodiment, the wireless data transmission system is a radio frequency identification (or “RFID”) system, and the portable data storage medium comprises a read/write memory chip having an embedded identification, onto which data may be recorded, or from which data may be read, by scanning the memory chip with an electromagnetic signal (e.g., RF or microwave) or other read/write means adapted for that purpose. One example of known technology incorporating such a memory chip with an embedded identification is the “iButton”™ manufactured by Dallas Semiconductor Corp.

As illustrated in FIG. 2, a further aspect of the invention is a scale data management system, generally denoted by reference numeral 10′, and comprising a scale computer 60, a scale database 62, and shipment data input means (which may alternatively be referred to as “second shipment data input means”) for entering data from the portable data storage medium into the scale database 62. In one embodiment, the second shipment data input means is a data medium reader 56 such as a bar code reader, memory card reader, magnetic card reader, floppy disc drive, or compact disc drive, to accommodate commodity shipments where the shipment data is recorded on a portable data storage medium 54 in the form of a bar code, memory card, magnetic card, floppy disc, or compact disc, respectively. In a further embodiment, the second shipment data input means comprises a wireless data receiver 58 to accommodate commodity shipments where the shipment data is recorded on a portable data storage means 54 in the form of an onboard database on the transport vehicle by means of the wireless data transmission system 52. In a yet further embodiment, the second shipment data input means comprises means for reading a memory chip, to accommodate situations where the shipment data is recorded on a portable data storage means 54 in the form of a read/write memory chip.

In the preferred embodiment, the second shipment data input means also includes a scale computer interface 64 and an associated monitor 66. The scale computer interface 64 may be a conventional computer keyboard or other similar type of keypad interface. In the preferred embodiment, however, the scale computer interface is a touchscreen interface. Whatever form the scale computer interface 64 may take, it allows the scale data management system 10′ to accommodate commodity shipments which were not loaded by a loader utilizing a loader data management system 10 in accordance with the present invention, such that the shipment data is produced at the scale in the form of a paper waybill. In such situations, the shipment data may be entered manually into the scale database 62 via the scale computer interface 64. Also in the preferred embodiment, the scale computer 60 will be programmed to display a language prompt and user-configurable prompts for entry of contract parameters and commodity attributes, including data filtering and “autofill” features, all essentially the same as described previously in connection with manual entry of shipment data into the loader computer database 22 via the loader computer interface 24.

Referring again to FIG. 2, the preferred embodiment of the scale data management system 10′ also includes scale data transfer means, for transferring selected data from the scale database to a location remote from the scale. The scale data transfer means may be a scale data recorder 70 of any suitable type, such as a such as a bar code writer, memory card writer, magnetic card writer, floppy disc drive, or compact disc burner. Data relating to one or more shipments received at the scale may thus be collected as desired on data storage media such as bar codes, memory cards, magnetic cards, floppy discs, or compact discs, which may then be transported to desired locations (such as the system user's administrative offices) where the data may be reviewed, audited, and analyzed as desired. In one alternative embodiment, the scale data transfer means comprises a wireless data transmission system 72, whereby selected data from the scale database 62 may be transmitted directly to a distant analysis location (such as the system user's CMF computer) for analysis, thus reducing or eliminating delays between when the data is collected and when it becomes available for review at the distant analysis point. The wireless data transmission system 72 may be any suitable system, such as a cellular digit packet data system, a private packet radio system, or a satellite packet data system.

It will be readily appreciated by those skilled in the art that various modifications of the present invention may be devised without departing from the essential concept of the invention, and all such modifications are intended to be included in the scope of the claims appended hereto.

What is claimed is:

1. A method for managing data relating to a shipment of harvested timber, said method comprising the steps of
(a) providing a mobile loader having:
a.1 a loader computer having a loader database;
a.2 first shipment data input means, for recording timber shipment data in the loader database;
a.3 shipment data output means, for recording data from the loader database on a portable electronically-readable data storage medium; and
a.4 a GPS receiver adapted to sample GPS data including geographic coordinates, said GPS receiver being in electronic communication with the loader computer for transmitting sampled GPS data to the loader database;
(b) providing a scale computer associated with a truck weigh scale, said scale computer having a scale database;
(c) providing, in association with the scale computer, second shipment data input means, for reading data from a portable, electronically-readable data storage medium and recording such data in the scale database;
(d) using the mobile loader, loading a quantity of harvested timber onto a truck at a geographic location proximal to the site at which the timber was harvested;
(e) by means of the GPS receiver, sampling GPS data corresponding to the mobile loader's geographic coordinates during step (d), and electronically transferring said sampled GPS data to the loader database;
(f) using the first shipment data input means, recording selected timber shipment data relating to the timber loaded onto the truck in step (d) in the loader database, and associating said timber shipment data with the GPS data transferred to the loader database in step (e);
(g) generating a timber shipment data record by recording said timber shipment data and associated GPS data from the loader database on a portable, electronically-readable data storage medium, using the shipment data output means;
(h) placing said portable data storage medium, containing the timber shipment data record, on or in the truck carrying the loaded timber shipment, and driving the truck to the truck weigh scale; and
(i) upon arrival of the truck at the weigh scale, using the second shipment data input means to read the timber shipment data record from the portable data storage medium, so as to download the corresponding GPS data and timber shipment data into the scale database.

2. The method of claim 1 wherein the first shipment data input means is selected from the group consisting of a keypad interface, a touch screen interface, and a wireless data receiver.

3. The method of claim 1 wherein the first shipment data input means is selected from the group consisting of a bar code reader, a memory card reader, a magnetic card reader, a floppy disc drive, and a compact disc drive.

4. The method of claim 1 wherein the portable, electronically-readable data storage medium is selected from the group consisting of a bar code printed on a waybill, a memory card, a magnetic card, a floppy disc, and a compact disc.

5. The method of claim 1 wherein the portable data storage medium is adapted for insertion into a computer on the truck, whereby data relating to operation of the truck may be recorded onto the portable data storage medium.

6. The method of claim 1 wherein the loader computer is programmed to begin recording GPS data from the GPS receiver upon receiving a signal from a loader motion detector associated with the mobile loader.

7. The method of claim 1 wherein the loader computer is programmed to record information from a signal interruption sensor associated with the GPS receiver, for detecting disruptions in GPS data transmissions from the GPS receiver to the loader database.

8. The method of claim 1, comprising the further step of providing scale data transfer means associated with the scale computer, for facilitating transfer of data from the scale database to a location remote from the scale, said scale data transfer means comprising a data recording device for recording selected data from the scale database onto a portable data storage medium.

9. The method of claim 8 wherein the data recording device is selected from the group consisting of bar code writer, memory card writer, magnetic card writer, floppy disc drive, and compact disc burner.

10. The method of claim 1 comprising the further steps of:
(a) providing scale data transfer means associated with the scale computer, for facilitating transfer of data from the scale database to a location remote from the scale, said scale data transfer means comprising, a wireless data transmission system; and
(b) transmitting data corresponding to the timber shipment data record from the scale database to a remote receiver via the wireless data transmission system.

11. The method of claim 10 wherein the wireless data transmission system comprises a system selected from the group consisting of a cellular digit packet data system, a private packet radio system, and a satellite packet data system.
